(19) United States
(12) Patent Application Publication
(10) Pub. No.: US 2014/0211456 A1
(43) Pub. Date: Jul. 31, 2014

(54) Illuminated Visual Display Container Having Minimal Glare

(71) Applicant: Richard Dale Hoy, Corpus Christi, TX (US)

(72) Inventor: Richard Dale Hoy, Corpus Christi, TX (US)

(21) Appl. No.: 13/750,899

(22) Filed: Jan. 25, 2013

(51) Int. Cl. F21V 33/00

(52) U.S. Cl. CPC F21V 33/0036
USPC 362/101

(57) ABSTRACT

An improvement to a lighted drinking container is provided. A problem exists with prior art illuminated drinking containers wherein glare hits the users' eyes upon use of the container (or upon tilting the glass towards the face to drink the liquid therein). The improvement disclosed herein provides an opaque or translucent barrier to allow for light to scatter away from the eye of the user, thus making the use of the container more comfortable while maintaining the illumination features thereof.

### CROSS REFERENCE TO RELATED APPLICATIONS

None.

### TECHNICAL FIELD

The present invention generally relates to containers and, in particular, the present invention relates to a container having a peripheral wall space or cavity and a means for lighting the peripheral wall space or cavity. It further relates to a means of minimizing or avoiding glare, as defined herein, which results to a user when drinking from the container when in a lighted mode.

### DESCRIPTION OF RELATED ART

Illuminated containers are available in the marketplace and are well known in the art. While the light-up features of the containers vary, a common problem is the direct light, as defined herein, or “glare”, which hits the user's eyes or eye area upon drinking any liquid while using the illuminating container.

It has been found that generally, illuminated containers having a peripheral wall space or cavity where light travels through, direct a significant amount of light through, for example, the rim of the container, causing the user to experience glare upon drinking liquids therefrom. It has also been found that in illuminated containers having a single wall layer light travels up the wall, or diffracts in various directions, causing a significant amount of light to hit the user's eyes upon use. Whenever intense light reaches the user's eye area, discomfort or a bothersome feeling occurs, ultimately leading the user to minimize or not use the lighted feature of the container. Numerous patents exist regarding lighted containers or light sources for containers, and improvement on the light itself The literature that discloses lighted containers has no indication that a problem exists when a user is utilizing the container with the light turned ‘on’.

In general, “brightness” is an expression of the amount of light emitted from a surface per unit of area, and correlates with visual quality, especially in relation to contrast and glare.

Brightness also is used to describe the subjective sensation of light intensity. This sensation largely depends on the overall layout of the scene being viewed and is described as glare. There is an uncomfortable level of brightness to the eyes as a user is drinking from a lighted or illuminated container. This discomfort is referred to herein as bothersome to the eye, or glare. This problem with glare to the eye has been found with both single and double walled containers. The present invention discloses a solution to this glare problem, with an improved design over that described in the art, and in particular U.S. Pat. No. 6,923,549 and U.S. Pat. No. 6,511,196.

During the course of commercialization, the inventor observed and experienced that the upper rim of the inner container that is attached to the outer container allows light from the peripheral wall space or cavity to exit through the upper rim. This causes an uncomfortable level of brightness to the eyes as a user is drinking from the container. This discomfort is bothersome to the eye and is termed as glare.

In light of the foregoing discussion, there exists a need for providing an illuminated container that will minimize direct light and maximize scattered light, as defined herein, from the light source, thus eliminating the glare that is experienced by a user when drinking from the illuminated container. In addition, the improvements must be aesthetically pleasing to allow for successful commercialization, and provide unobstructed and effective illumination of any text, image, or pattern displayed on or within the container, such as a message and/or design that appears on any paper insert and/or interior liner, any textile insert and/or interior liner, any metallic insert and/or interior liner, any paper and/or plastic and/or textile and/or metallic interior and/or exterior sleeve, cap, and/or any surface of the container. For clarity herein, a cap is a sleeve, e.g., vacuum formed that slides over the lip of the container.

### SUMMARY

U.S. Pat. No. 6,923,549 B2 (US'549) describes an illuminated container which allows for an interior visual display. US'549 is continuation-in-part application of now granted U.S. Pat. No. 6,511,196 (US'196), both patents herein incorporated by reference. It has now been found that containers described in US'549 and US'196 direct glare upon the user's eye area when the container is illuminated and in use for drinking. The present invention is an improvement upon the illuminated containers found in the art, in particular as described in US'549 and US'196.

During the course of commercialization, the inventor observed and experienced that light from the peripheral wall space or cavity transmits or exits through the upper rim attached to both the inner and outer containers. This causes an uncomfortable level of brightness to the eyes as a user is drinking from the container. This discomfort is bothersome to the eye and is termed glare.

As used herein, the terms inner container and outer container are used interchangeably with the term inner and outer wall of the illuminated container or glass.

Generally, illuminated or lighted containers, when tipped towards the drinker, will place a stream of light around or at eye level of the user, causing an uncomfortable glare. This problem has not been recognized in the past. The improved container of the present invention houses an opaque or translucent rim or barrier at or near the upper edge of the inner container. The rim or barrier is attached to the outer container, or between the inner and outer walls of the illuminated container. Alternatively, or in addition, the improved container of the present invention houses an opaque or translucent inner or outer container wall. Alternatively, or in addition, the improved container peripheral wall space or cavity is provided with filler so as to diffuse, minimize, or avoid direct light leaving the container and maximize scattered light within the container, thus minimizing or eliminating glare that is experienced by the user when drinking from the lighted container. The barrier blocking the light from the user makes using the container more comfortable.

Further details and advantages will become apparent from the annexed drawings and the discussion that follows.

In an embodiment of the present invention, an illuminated container is provided and comprises an outer container having a peripheral wall and a bottom at a first end of the peripheral wall. An inner container has a peripheral wall and a bottom at a first end of the peripheral wall. The outer container surrounds the inner container, such that the outer and inner containers are substantially concentric about a first axis. The outer and inner containers define a space or cavity therebetween. A rim is disposed between the outer and the inner containers, which joins the peripheral walls of the outer and inner containers. Optionally, the rim is positioned at a second end of the inner peripheral wall and at a second end of the outer peripheral wall. At least one light source is positioned beneath the bottom of the outer container along the first axis, such that the light source directs light through the outer container bottom, into the peripheral wall space or cavity and onto the inner container and the rim.

In another embodiment of the present invention, an illuminated container is provided. The illuminated container includes an outer container that has a peripheral wall and a bottom. The outer container peripheral wall and bottom are partially light-pervious. An inner container having an outer surface is positioned partially within the outer container to form a peripheral wall space or cavity between the inner and outer containers. At least one light source is positioned beneath the outer container bottom in a vertical alignment with the peripheral wall space or cavity, such that the light source directs light through the outer container bottom, into the peripheral wall space or cavity and on to the inner container outer surface. The illuminated portion of the inner container outer surface is partially visible through the outer container peripheral wall. A rim is disposed between the outer and the inner containers, which joins the peripheral walls of the outer and inner containers, such that at least one of the inner container, the outer container, the rim, an optional filler material, and combinations thereof is configured to substantially reduce a glare produced by the light. The reduction in glare was found to be from between 99% to 5% as compared to a container having a clear outer walled container, a clear inner walled container, a clear rim, and a vacant peripheral wall space or cavity.

### BRIEF DESCRIPTION OF DRAWINGS

The invention is described in detail below with reference to the drawings, wherein like numerals designate similar parts and wherein:

FIGS. 1 and 1A illustrate an example light testing setup for an illuminated container;

FIG. 2 illustrates a prior art illuminated container with clear walls;

FIG. 3 illustrates an illuminated container with a clear outer wall, an opaque inner wall and an opaque rim;

FIG. 4 illustrates an illuminated container with a translucent outer wall, a translucent inner wall and a translucent and/or iridescent material disposed in a space or cavity defined by the inner and outer walls;

FIG. 5 illustrates an illuminated container with a clear outer wall, a clear inner wall and an opaque rim; and

FIGS. 6 and 7 are graphs illustrating experimental results of various lighting tests, in accordance with various embodiments of the present invention.

### DETAILED DESCRIPTION OF PREFERRED EMBODIMENTS

The invention is described in detail below with reference to the drawings. Such discussion is for purposes of illustration only. Modifications within the spirit and scope of the present invention, set forth in the appended claims, will be readily apparent to one of skill in the art. Terminology used throughout the specification and claims herein is given its ordinary meaning as defined by the American Heritage Dictionary, the Merriam-Webster Online Dictionary, the Macmillan Dictionary, and Digital Lighting & Rendering by Jeremy Bim, consistent with the exemplary definitions set forth immediately below.

Glare—An intense, blinding light; to shine with a harsh uncomfortably brilliant light; to shine with a very strong light that makes you feel uncomfortable.

Direct Light—Light that travels in a straight line from a light source to a surface which it illuminates.

Scattered Light—Light that has bounced off of other surfaces, or has been scattered or reflected or focused by other surfaces, before illuminating an object.

Rim—The upper or outer edge of an object, or herein, of the container; the edge of an open container or circular object; the outer often curved or circular edge or border of something.

Opaque—Is difficult to see through; impenetrable by light; neither transparent nor translucent; blocking the passage of radiant energy and especially light.

Translucent—Light with sufficient diffusion to prevent perception of distinct images; transmitting and diffusing light so that objects beyond cannot be seen clearly.

Clear—Easily seen through.

Iridescent—Showing changing colors in different types of light; having or exhibiting a display of colors producing rainbow effects.

Brightness also is used to describe the subjective sensation of light intensity. This sensation largely depends on the overall layout of the scene being viewed. Extreme brightness may be described as glare.

Each of the embodiments, herein described, have been constructed allowing for the amount of direct light present in the peripheral wall space or cavity and exiting through the upper rim of the inner container that is attached to the outer container to be measured using a standardized measuring fixture, standardized light source, light switch (on/flash/off), and industrial grade light meter.

The inventive embodiments described herein minimize direct light and maximize scattered light from the light source, thus eliminating the glare that is experienced by a user when drinking from prior art container embodiments, (US'549 and US'196) while providing aesthetically pleasing, unobstructed and effective illumination of a message and/or design that appears on a paper insert and/or interior liner, a plastic insert and/or interior liner, a textile insert and/or interior liner, a metallic insert and/or interior liner, a paper and/or plastic and/or textile and/or metallic sleeve, cap, and/or any surface of the container.

An embodiment of the present invention provides an illuminated container, comprising an outer container wall made of clear material and the inner container wall made of opaque material. Opaque material as defined herein may include a material which in and of itself is opaque or dark to the eye, or can include the use of a coating, a paper insert and/or interior liner, a plastic insert and/or interior liner, a textile insert and/or interior liner, a metallic insert and/or interior liner, a paper and/or plastic and/or textile and/or metallic sleeve, cap, or some other method, such as textured surfaces and/or additives to the base material that functions as an opaque material and/or appears to a viewer to be opaque.

The bottom of the outer container is the same for all embodiments described herein, and may be clear or be made of translucent material. Translucent is as defined hereinabove. A translucent material is further defined herein to include a material in and of itself translucent, or a material that through the use of a coating, a paper insert and/or interior liner, a plastic insert and/or interior liner, a textile insert and/or interior liner, a metallic insert and/or interior liner, a paper and/or plastic and/or textile and/or metallic sleeve, cap, or some other method, such as textured surfaces and/or additives to the base material, is made to function as a translucent material and/or to appear to a viewer to be translucent. Relative to the bottom, it is as described in US '549, and US '196, with perhaps additional lights as the user may desire, including any colors the user may desire. While lights may be present around the perimeter of the container, a light may also optionally be positioned at the bottom center of the container to allow light to shine directly through, and upwards towards the liquid inside.

For all embodiments, at least one light source sufficient to illuminate a visual display is utilized. The source may be white light and/or colored light, and is positioned on any surface of the container in order to introduce light directly into the peripheral wall space or cavity to create an illuminated peripheral wall space or cavity. Preferably the light source is at the base of the container, but may also be along the peripheral wall space or cavity. It may also be on and/or along the rim or upper portion of the container. Other sources of light may be placed on the top portion of the container. While the light source may be bulbs or light emitting diodes (LEDs), they may also be in the form of a light emitting sheet or other industry acceptable manner or device, which fits within the confines of the presently described container. While glare can be minimized by limiting or reducing light intensity, one has to balance intensity with the ability to illuminate the visual display for maximum effect.

The present invention relates to an illuminated container, comprising an outer container having a peripheral wall and a bottom at a first end of the peripheral wall;

an inner container having a peripheral wall and a bottom at a first end of the peripheral wall,

wherein the outer container surrounds the inner container such that the outer and inner containers are substantially concentric about a first axis,

and wherein the outer and inner containers define a space or cavity therebetween;

a rim disposed between the outer and the inner containers, wherein the rim joins the peripheral walls of the outer and inner containers; and

at least one light source positioned such that the light source directs light into the peripheral wall space or cavity and onto the inner container and out through the rim.

The outer container may be substantially clear, or may be substantially translucent. The inner container may be substantially opaque, or may be substantially translucent, or may be substantially clear. The upper rim of the inner container, (and attached to the outer container), may be substantially opaque, or may be substantially translucent, or may be substantially clear. The upper rim and combinations thereof are configured to reduce a glare produced by the light source from between 99% to 5% compared to the control container. Preferably is an upper rim and combinations thereof configuration to reduce a glare produced by the light source about 60% when compared to the control container. As defined herein, substantially clear refers to the transmittance of a material wherein only a nominal amount of attenuation or absorption is present; substantially translucent refers to the transmittance of a material wherein at least about 10% of incident light is scattered; and substantially opaque refers to the transmittance of a material wherein less than about 50% of incident light is transmitted.

The peripheral wall space or cavity may be substantially vacant, or may be provided with a filler material that is configured to reduce the glare produced by the light source. Preferably reduction in glare is from between about 66% to about 52% compared to the control container.

The illuminated container may also include at least one light source, for example, a bulb or a light emitting diode (LED), a light emitting sheet or other industry acceptable material or device, which fits within the confines of the presently described container.

Alternatively, an illuminated container is disclosed, comprising:

an outer container having a peripheral wall and a bottom, the outer container peripheral wall and bottom being at least partially light-pervious;

an inner container having an outer surface, the inner container positioned at least partially within the outer container to form a peripheral wall space or cavity between at least a portion of the inner container outer surface and the outer container peripheral wall;

at least one light source positioned such that the light source directs light into the peripheral wall space or cavity and on to the inner container outer surface, the illuminated portion of the inner container outer surface being at least partially visible through the outer container peripheral wall; and

a rim disposed between the outer and the inner containers, wherein the rim joins the peripheral walls of the outer and inner containers, wherein at least one component selected from the inner container, the outer container, the rim and combinations thereof is prepared from a suitable material and/or is configured to substantially reduce a glare produced by light exiting through the rim and upper edge of the container walls as compared to a container having a clear outer walled container, a clear inner walled container, a clear rim, and a vacant peripheral wall space or cavity through which light travels.

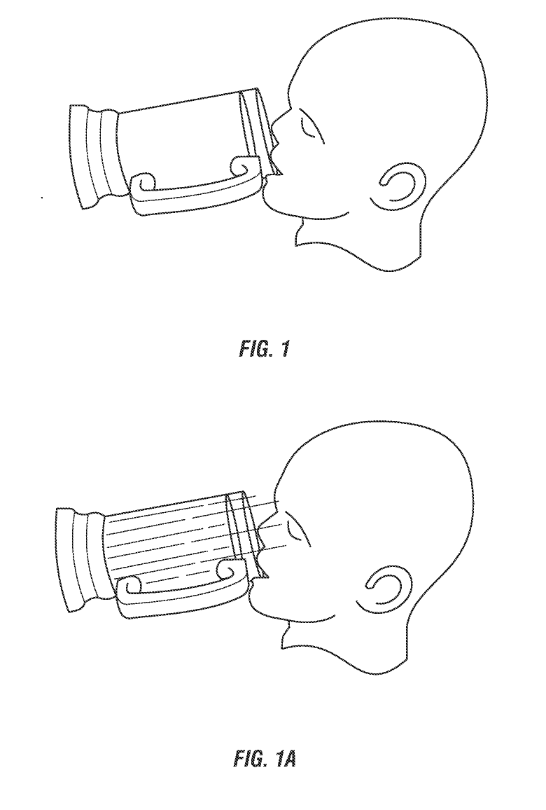

Referring now to FIGS. 1 and 1A, an example light testing setup for an illuminated container, is shown without the battery pack. The light testing setup is used to measure the amount of glare that is observed by the user's eyes. FIG. 1 illustrates use of the glass without the illumination, while FIG. 1A illustrates the glass in a lighted mode. It is evident that a glare exists and forms around the eye area of the user, which is undesirable. FIG. 1A demonstrates the use position of the prior art illuminated containers.

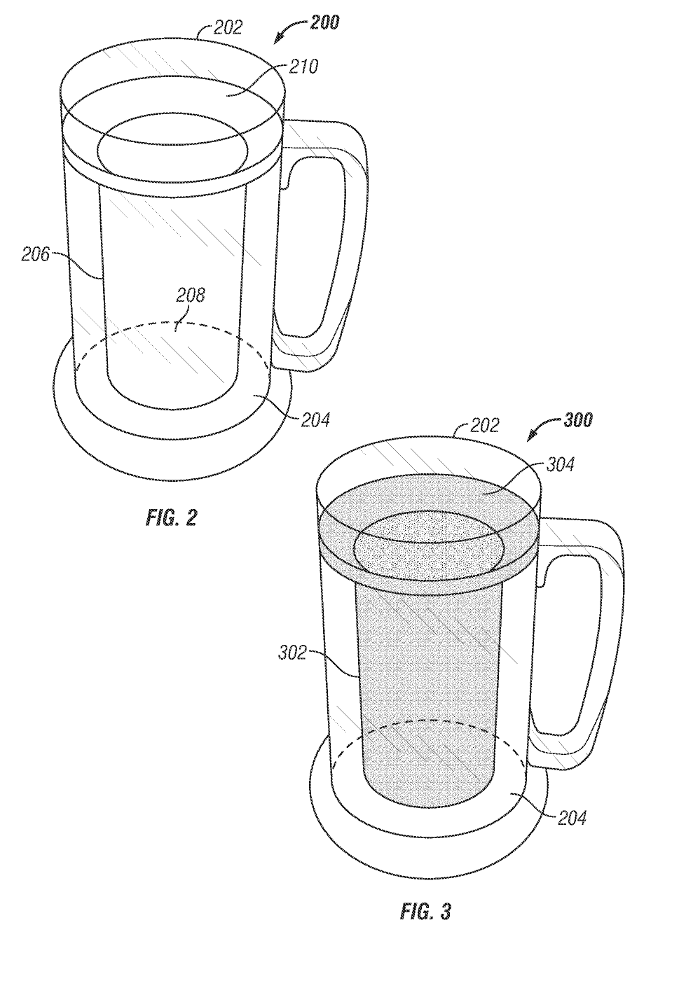

FIG. 2 illustrates a prior art illuminated container (interchangeably referred to as the ‘Control Container’) with clear walls. The control container 200 includes an outer container formed by a peripheral wall 202 and a base 204 attached at the bottom of the peripheral wall 202. An inner container is housed inside the outer container 202 and is formed by a peripheral wall 206 and a base 208 attached at the bottom of the peripheral wall 206. The outer and inner containers define a space or cavity therebetween that is sealed by a rim 210. The rim can be straight across or angled to form a slant. The outer container, the inner container and the rim 210 are made of a clear material, and there is provided a light source at the bottom of the outer container, as disclosed by U.S. Pat. Nos. 6,923,549 and 6,511,196, entire contents of which are herein incorporated by reference. The light source may be anything used as a standard in the industry and also as described in US '549 and US'196. The base of the container may be as described and employed by the industry for holding a light source and compatible with the containers' multiple walls. As described in the foregoing description, the control container when illuminated, results in a glare around the eyes of the user.

Referring now to FIG. 3, an illuminated container 300 with a clear outer wall 202, an opaque inner wall 302 and an opaque rim 304, in accordance with an embodiment of the present invention, is shown. The illuminated container 300 is similar in construction to the illuminated container 200 of FIG. 2 and additionally includes the opaque inner wall 302 and the opaque rim 304. This embodiment was found to reduce glare experienced by the user by about 99%. Additional details of the opaque wall and the opaque rim are provided in the forthcoming description.

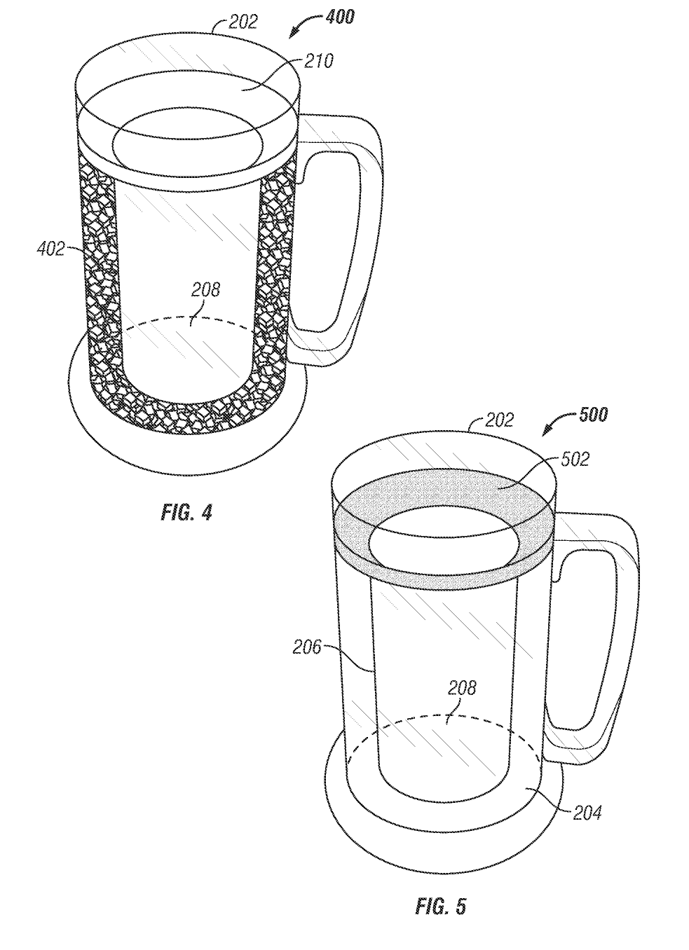

FIG. 4 illustrates an illuminated container 400 with a translucent outer wall, a translucent inner wall and a translucent and/or iridescent filler material 402 disposed in a space or cavity defined by the inner and outer walls, in accordance with an embodiment of the present invention. The illuminated container 400 is similar in construction to the illuminated container 200 of FIG. 2, and additionally includes filler material in the cavity. In various embodiments of the present invention, the translucent material includes, but is not limited to, frosted glass, sheer cloth, tracing paper, chipped plastics, and the like. Alternatively, any suitable iridescent material can be used, without departing from scope and spirit of the present invention. The objective behind using such a material is to minimize direct light and maximize scattered light and to produce light of varied colors giving an aesthetically pleasing effect to the user.

This configuration limits the ability to easily see any visual display printed on the inner container wall, and hence it is preferred that any display be on the outer container wall. This embodiment was found to reduce glare experienced by a user by about 66%. FIG. 5 illustrates an illuminated container with a clear outer wall, a clear inner wall and an opaque rim 502, in accordance with an embodiment of the present invention. The illuminated container 500 is similar in construction to the illuminated container 200 of FIG. 2 with the additional feature of an opaque rim. This arrangement allows for maximum printability on all available surfaces of the illuminated container, and also allows for illumination of any liquid inside the container. This embodiment was found to reduce glare experienced by a user by about 52%.

A skilled artisan would appreciate that while FIGS. 2-5 describe various configurations of the illuminated container of the present invention, numerous other configurations are possible. Further, while the embodiments are described for holding liquids, other items may be placed or stored in the containers and illuminated with the light source. The illuminated container may also be used as a non-drinking tool, but one employed for storage of smaller items, or as a showcase item. Some of the exemplary configurations are explained below:

An embodiment of the present invention provides an illuminated container comprising an outer container wall made of clear material and inner container wall made of opaque material and the upper rim of the inner container, (and attached to the outer container), made of opaque material.

In another embodiment, an illuminated container is described that includes an outer and inner container wall and the upper rim of the inner container, (and attached to the outer container), made of translucent material as defined herein. The peripheral wall space or cavity that is formed between the inner surface of the outer container wall and the outer surface of the inner container wall is filled with clear and/or translucent and/or iridescent material.

In yet another embodiment, an illuminated container is described that includes an outer and inner container wall and the upper rim of the inner container, (and attached to the outer container), made of clear material and the peripheral wall space or cavity is filled with clear and/or translucent and/or iridescent material.

Another embodiment involves an illuminated container, which includes an outer container wall made of clear material and the inner container wall and the upper rim of the inner container, (and attached to the outer container), made of translucent material wherein the space or cavity is filled with clear and/or translucent and/or iridescent material.

In a further embodiment, an illuminated container including an outer container wall made of translucent material and the inner container wall and the upper rim of the inner container, (and attached to the outer container), made of clear material. The peripheral wall space or cavity that is formed between the inner surface of the outer container wall and the outer surface of the inner container wall is filled with clear and/or translucent and/or iridescent material.

In yet another embodiment, an illuminated container is disclosed, comprising an outer and inner container wall made of clear material, and the upper rim of the inner container, (and attached to the outer container), is made of opaque material or through the use of a coating, a paper insert and/or interior liner, a plastic insert and/or interior liner, a textile insert and/or interior liner, a metallic insert and/or interior liner, a paper and/or plastic and/or textile and/or metallic sleeve, cap, or some other method, such as textured surfaces and/or additives to the base material, is made to function as an opaque material and/or to appear to the eye as an opaque material.

In another embodiment, an illuminated container is disclosed, comprising an outer and inner container wall and the upper rim of the inner container, (and attached to the outer container), made of translucent material.

Another embodiment, involving an illuminated container, comprises an outer container wall made of clear material and the inner container wall and the upper rim of the inner container, (and attached to the outer container), made of translucent material.

In a further embodiment, an illuminated container is disclosed, comprising an outer container wall made of translucent material, and the inner container wall and the upper rim of the inner container, (and attached to the outer container), made of clear material.

In yet another embodiment, an illuminated container, comprising an outer container wall made of clear material and the inner container wall made of clear material, and the upper rim of the inner container, (and attached to the outer container), made of translucent material.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

While the light source described herein comprises bulbs or light emitting diodes, the light source may also be in the form of a light emitting sheet or other industry acceptable device, which fits within the confines of the presently described container. For example a bulb, a light emitting diode, a light emitting sheet, a light with a solar panel, a regular or rechargeable type battery system, or any other light emitting source commonly found in the commercial market. The light provided can be white or of any color or combination of colors, but is preferably red, green, blue to allow for a mixing of the light to form other colors. The light can be steady or flashing, whatever is most comfortable and desirable for the user.

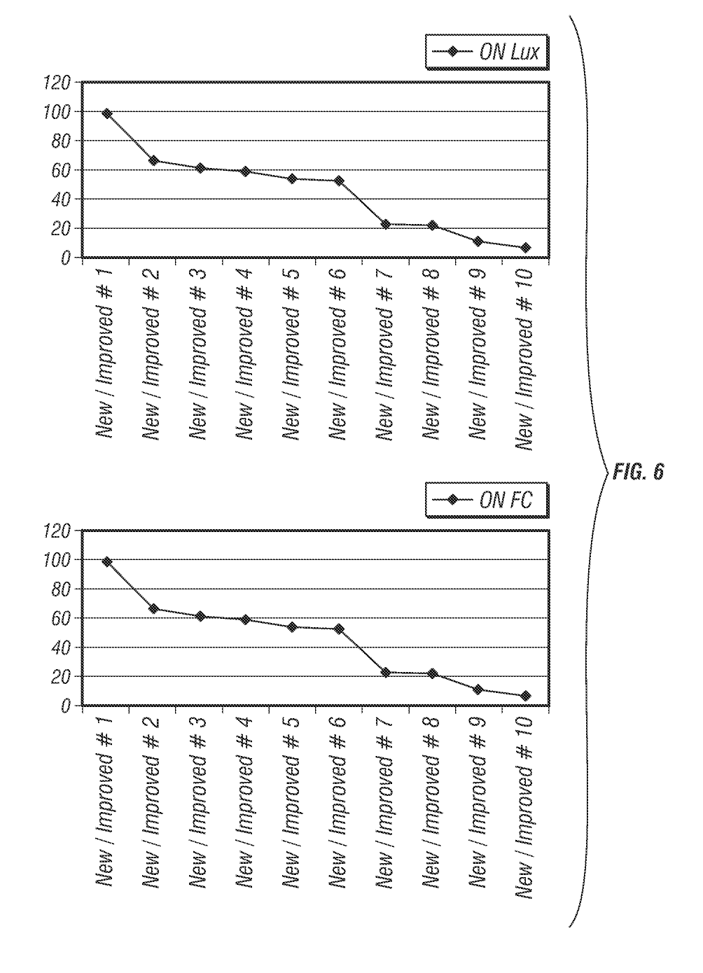

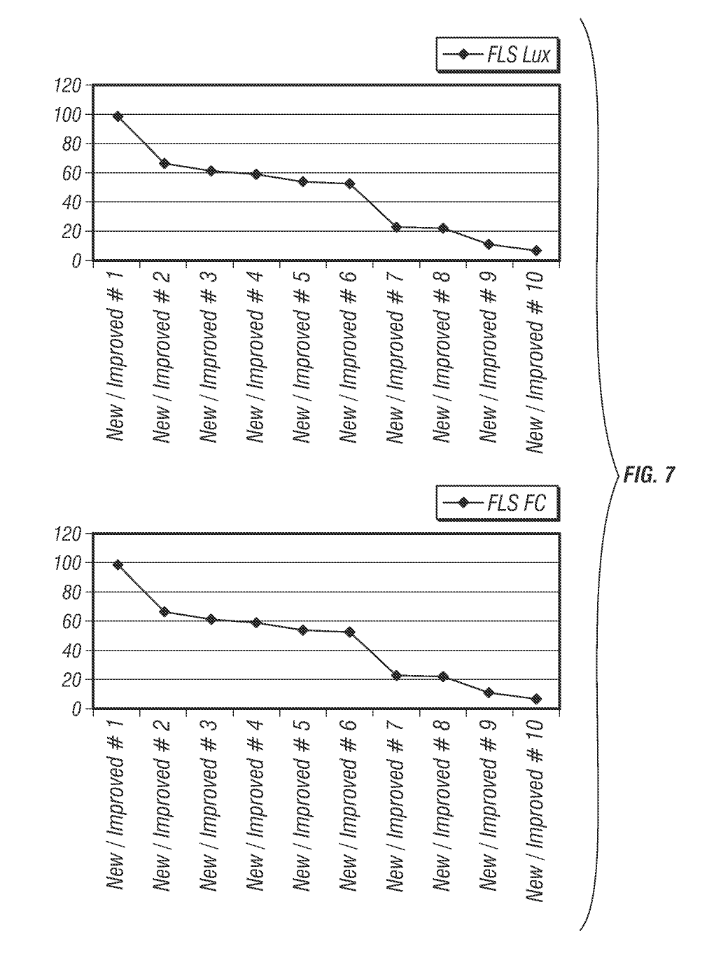

FIGS. 6 and 7 are graphs illustrating experimental results of various lighting tests, in accordance with various embodiments of the present invention.

### EXAMPLES

The experiment conducted measured the direct light, or glare, emitted from the container with an illuminated interior visual display by a user while drinking from the illuminated container.

Each of the embodiments, herein listed, were constructed to allow the direct light transmitted through the peripheral wall space or cavity and through the upper rim to be measured using a standardized measuring fixture, standardized light source, light switch (on/flash/off), and industrial grade light meter.

Comparative experiments were similarly conducted to measure the direct light or glare emitted from a control container, such as one described in US Pat. Nos. US'549 and US'196, and as discussed above. The containers were designed as described below, with each number representing the noted numbered container. The control container was made of all clear components.

1. The outer container wall was made of clear material and the inner container wall and the upper rim of the inner container, (and attached to the outer container), were made of opaque material. The opaque feature of the invention can be any color desirable to the user. For example, chrome, black, or any dark colors, or any light colors which reflect light away from the user's eye area can be employed. A cap or sleeve, preferably plastic but any suitable material, can also be used to create the opaque feature. This embodiment was found to reduce glare experienced by the user by about 99% compared to the control container.

2. The outer container wall was made of translucent material and the inner container wall and the upper rim of the inner container, (and attached to the outer container), were made of translucent material. The peripheral wall space or cavity was filled with clear and/or translucent and/or iridescent material. This embodiment was found to reduce glare experienced by the user by about 66% compared to the control container.

The filler material should be considered relative to the desired location of any visual display on the container. Having filler material within the space or cavity of the container can limit the location of the visual display since less surface area is available for an easily viewed display. For example, it may be difficult to see a display which is printed on the inner container wall and essentially behind the filler material.

3. The outer container wall was made of clear material and the inner container wall and the upper rim of the inner container, (and attached to the outer container), were made of a clear material. The cavity was filled with clear and/or translucent and/or iridescent material. This configuration is especially desirable due to the visual effect obtained once the container is filled with liquid and the light causes a glow throughout the container, the display utilized, and the liquid within the container. A limitation for the visual display is that printing on the inner container cannot be easily observed through the outer container wall. This embodiment was found to reduce glare experienced by the user by about 60% compared to the control container.

4. The outer container wall was made of clear material and the inner container wall and the upper rim were made of a translucent material. The peripheral wall space or cavity was filled with clear and/or translucent and/or iridescent material. This embodiment was found to reduce glare experienced by the user by about 59% compared to the control container.

5. The outer container wall was made of translucent material and the inner container wall and the upper rim were made of clear material. The peripheral wall space or cavity was filled with clear and/or translucent and/or iridescent material. This embodiment was found to reduce glare experienced by the user by about 52% compared to the control container.

6. The outer container wall, and the inner container wall were made of clear material, and the upper rim of the inner container, (and attached to the outer container), was made of opaque material. This embodiment was found to reduce glare experienced by the user by about 52% compared to the control container.

7. The outer container wall, the inner container wall and the upper rim were made of translucent material. This embodiment was found to reduce glare experienced by the user by about 22% compared to the control container.

8. The outer container wall was made of clear material and the inner container wall and the upper rim of the inner container were made of translucent material. This embodiment was found to reduce glare experienced by the user by about 21% compared to the control container.

9. The outer container wall was made of translucent material and the inner container wall and the upper rim of the inner container were made of clear material. This embodiment was found to reduce glare experienced by the user by about 10% compared to the control container.

10. The outer container wall and the inner container wall were made of clear material, and the upper rim was made of translucent material. This embodiment was found to reduce glare experienced by the user by about 5% compared to the control container.

The experiments provided data to quantify, in Lux and Foot Candles, the amount of direct light or glare being transmitted to the user's eyes when the container is positioned as if a user was drinking therefrom. Data from the various container-embodiments were compared to the control container and the amount of change in glare detectable by a user as he/she was drinking from the improved subject container was measured. All containers disclosed are aesthetically pleasing, minimize glare, and allow for at least one surface to place a visual display or design which can be illuminated.

### Experiment Procedure

A. Equipment and Materials
The following equipment and materials were utilized for measuring glare during use of the containers:
The measuring fixture allowed for identical placement of the containers as shown in FIGS. 1 and 1A. A standard battery pack was employed to power the operating light source for the present experiments. The light source allowed for identical illumination of containers (FIG. 1A illustrates light transmission with light source on)
Light Switch: allows for On/Flash/Off
3 new AAA batteries were utilized for each measurement
Industrial grade light meter
Control container (FIG. 2)
Container #1 (FIG. 3)
Container #2 (FIG. 4)
Container #3
Container #4
Container #5
Container #6 (FIG. 5)
Container #7
Container #8
Container #9
Container #10

B. Steps Taken to Conduct the Experiments 15
1. Located a space in which internal and external illumination can be controlled.
2. Positioned the Measuring Fixture on a table.
3. Placed 3 New Batteries in the Power Source for the Light Source.
4. Attached the Control Container to the Light Source.
5. Positioned the Control Container in the Container Holding Fixture.
6. Positioned the Light Meter Sensor in the Sensor Holding Fixture.
7. Activated the Light Meter.
8. Activated the Light Source (On Mode)
9. Logged the Lux reading from the Meter.
10. Logged the Foot Candle reading from the Meter.
11. Activated the Light Source (Flashing Mode)
12. Logged the Lux reading from the Meter.
13. Logged the Foot Candle reading from the Meter.
14. Removed the Control Container from the Container Holding Fixture.
15. Detached the Control Container from the Light Source.
16. Aside the Control Container.
17. Repeated Steps 3 thru 16 for Containers #1 thru #10.

### Experimental Data and Results

The data noted herein were as displayed by the AMPROBE LM-200LED light meter for the control container and each of the numbered containers #1 thru #10. A decrease in value means a reduction of glare, hence #1 value is best for scattering light away from the user, and #10 value is considered least desirable from a glare reduction perspective. To validate the measurements for LUX, experiments were conducted measuring Foot Candle (FC). The data obtained between FC and LUX results were consistent and hence considered validated.

DATA TABLE 1
Direct Light “Glare” Data Table
ACTUAL METER READINGS

| | | ON - Foot | | Flash - Foot |
|---|---|---|---|---|
| | ON - Lux | Candle | Flash - Lux | Candle |
| CONTAINER | Range 200 | Range 200 | Range 200 | Range 200 |
| Control | 250 | 23.5 | 246 | 11.2 |
| Container | | | | |
| Container #1 | 4 | .3 | 3 | .2 |
| Container #2 | 85 | 7.8 | 82 | 3.8 |
| Container #3 | 100 | 9.2 | 97 | 4.4 |
| Container #4 | 102 | 9.6 | 99 | 4.6 |
| Container #5 | 118 | 11.0 | 114 | 5.3 |
| Container #6 | 119 | 11.1 | 116 | 5.3 |
| Container #7 | 195 | 18.3 | 191 | 8.7 |
| Container #8 | 197 | 18.4 | 193 | 8.8 |
| Container #9 | 223 | 21.0 | 219 | 10.0 |
| Container #10 | 236 | 22.1 | 233 | 10.6 |

Direct Light “Glare” Data Table 2
Observed “glare” as a PERCENTAGE of Control
(Control Container = 100%)

| | | ON - Foot | | Flash - Foot |
|---|---|---|---|---|
| | ON - Lux | Candle | Flash - Lux | Candle |
| CONTAINER | Range 200 | Range 200 | Range 200 | Range 200 |
| Control | 100.00% | 100.00% | 100.00% | 100.00% |
| Container | | | | |
| Container #1 | 99.84% | 98.72% | 98.78% | 98.21% |
| Container #2 | 66.00% | 66.80% | 66.66% | 66.07% |
| Container #3 | 60.00% | 60.85% | 60.56% | 60.71% |
| Container #4 | 59.20% | 59.14% | 59.75% | 58.92% |
| Container #5 | 52.80% | 53.19% | 53.66% | 52.67% |
| Container #6 | 52.40% | 52.76% | 52.85% | 52.67% |
| Container #7 | 22.00% | 22.12% | 22.35% | 22.32% |
| Container #8 | 21.20% | 21.70% | 21.54% | 21.42% |
| Container #9 | 10.80% | 10.63% | 10.97% | 10.71% |
| Container #10 | 5.60% | 5.95% | 5.25% | 5.35% |

The results are presented graphically in FIGS. 6 and 7 and illustrate, as compared to the Control Container, that each of the experimental configurations for the numbered containers provide a decrease in Direct Light that hits the users' eyes upon use of the container (or upon tilting the glass towards the face to drink the liquid therein).

All containers having at least one surface and/or the rim opaque were found to minimize glare during use while illuminated. However it appears that even at least a translucent rim reduces the glare sufficiently to increase comfortable use such that the light is not bothersome to the user. Container 3 can have a visual display on the outside of the container wall.

While the invention has been described in detail, modifications within the spirit and scope of the invention will be readily apparent to those of skill in the art. It should be understood that aspects of the invention and portions of various embodiments may be combined or interchanged either in whole or in part. Furthermore, those of ordinary skill in the art will appreciate that the foregoing description is by way of example only, and is not intended to limit the invention. The discussion herein is focused on the problem associated with glare of an illuminated container, and not with the manufacture of such a container. The container can be manufactured by standard industry processes such as injection molding, vacuum forming, or the like. Those skilled in the art will recognize other methods which do not deter from the scope herein.

What is claimed is:

1. An illuminated container, comprising
an outer container having a peripheral wall and a bottom at a first end of the peripheral wall;
an inner container having a peripheral wall and a bottom at a first end of the peripheral wall,
wherein the outer container surrounds the inner container such that the outer and inner containers are substantially concentric about a first axis,
and wherein the outer and inner containers define a space or cavity therebetween;
a rim disposed between the outer and the inner containers, wherein the rim joins the peripheral walls of the outer and inner containers;
at least one light source positioned such that the light source directs light into the peripheral wall space or cavity and onto the inner container, transmitting light through the cavity and rim and forming a glare to a user of the container, and,
configuring at least one of the outer container, inner container, cavity, and rim to result in a reduction of glare produced by the light source as compared to a container having a clear outer walled container, a clear inner walled container, a clear rim, and a vacant peripheral wall space or cavity.

2. The illuminated container of claim 1, wherein the outer container is substantially clear.

3. The illuminated container of claim 1, wherein the inner container is substantially opaque.

4. The illuminated container of claim 1, wherein the rim is substantially opaque.

5. The illuminated container of claim 1, wherein the outer container is substantially translucent.

6. The illuminated container of claim 1, wherein the inner container is substantially translucent.

7. The illuminated container of claim 1, wherein the rim is substantially translucent.

8. The illuminated container of claim 1, wherein the cavity contains filler material.

9. The illuminated container of claim 1, wherein the inner container is substantially clear.

10. The illuminated container of claim 1, wherein the rim is substantially clear.

11. The illuminated container of claim 1, wherein a rim disposed between the outer and the inner containers, joins the peripheral walls of the outer and inner containers, such that at least one component selected from the group consisting of the outer container, the inner container, the rim, an optional filler material, and combinations thereof is selected and configured to reduce a glare produced by a light source from between 99% to 5% as compared to an illuminated container having a clear outer walled container, a clear inner walled container, a clear rim, and a vacant peripheral wall space or cavity.
